(19) United States
(12) Patent Application Publication
(10) Pub. No.: US 2025/0050255 A1
(43) Pub. Date: Feb. 13, 2025

(54) MODULE OF FILTER HEAD FOR WATER PURIFIER

(71) Applicant: OVIO Co., Ltd., Hwaseong-si (KR)

(72) Inventor: Namsoo KIM, Hwaseong-si (KR)

(21) Appl. No.: 18/750,196

(22) Filed: Jun. 21, 2024

(30) Foreign Application Priority Data
Aug. 9, 2023 (KR) 10-2023-0103915

(51) Int. Cl. B01D 35/30

(52) U.S. Cl. CPC B01D 35/306; B01D 2201/40

(57) ABSTRACT

Provided is a filter head module for a water purifier, which is easy to assemble or disassemble filters, blocks leakage due to combination of a plurality of filter heads, prevents separation of parts, and sufficiently satisfies physical properties such as prevention of eccentricity. The module includes a plurality of filter heads including each filter accommodation part in which a filter part is accommodated, and a connection part for connecting the filter heads, wherein each of the filter heads includes a housing, a second cap and a collet, the second cap is coupled to the housing, and the collet is in close contact with a fixing part of the connection part.

### BACKGROUND OF THE DISCLOSURE

### Technical Field

The present disclosure relates to a water purification device and, more specifically, to a filter head module for accommodating filters which are detachably attached to a water purification device such as a water purifier, cold/hot water dispenser, refrigerator, etc.

### Background

Water purification devices are to convert raw water such as tap water or groundwater into safe and hygienic drinking water by filtering various harmful components, which are contained in the raw water and harmful to the human body, by using filters or the like. A representative water purification device is a water purifier, A representative water purification device is a water purifier, and recently, refrigerators have been equipped with whole or part of such a water purification device, so purified water can be supplied through the refrigerator or used to make ice. A filter head accommodates a filter and has a bypass function so as to prevent leakage of raw water and maintain a flow path on a water purification line. In other words, raw water and purified water are prevented from mixing with each other. The filter head requires many functions such as bypass, backflow prevention, water supply blocking, and easy replacement. Various types of filter heads are presented in Korean registered patent No. 10-1409894, Korean patent publication No. 2021-0042456, and Chinese registered utility model No. 213610153.

Meanwhile, a filter is sometimes removed from a filter head for replacement and inspection. To this end, features such as easy assembly and disassembly of filters, combination of a plurality of filters, and water leak prevention are required. Korean registered patent No. 10-1976641 has suggested a filter head from which a filter can be separated. However, since parts are manufactured by assembling each other, they may be separated during movement. Additionally, when high water pressure is applied, gaps may occur between the parts, which may cause water leakage. Furthermore, since gaskets are installed in some areas, eccentricity may occur during assembly.

### SUMMARY OF THE DISCLOSURE

### Problems to be Solved

The present disclosure was derived to solve the above conventional problems, and it is an object of the present disclosure to provide a filter head module for a water purifier, which is easy to assemble or disassemble filters, blocks leakage due to combination of a plurality of filter heads, prevents separation of parts, and sufficiently satisfies physical properties such as prevention of eccentricity.

### Technical Solutions

In order to solve the problems, a filter head module for a water purifier according to the present disclosure includes a plurality of filter heads including each filter accommodation part in which a filter part is accommodated, and a connection part for connecting the filter heads. Herein, each of the filter heads includes a housing, a second cap and a collet, the second cap is coupled to the housing, and the collet is in close contact with a fixing part of the connection part.

In the module of the present disclosure, the housing and the second cap may be fused by ultrasonic waves. The filter head is positioned between an inlet part and an outlet part, the inlet part includes an inlet stem and a first cap, and the outlet part includes an outlet stem and a fifth cap. The inlet stem and the first cap may be fused by ultrasonic waves, and the outlet stem and the fifth cap may be fused by ultrasonic waves.

In the module of the present disclosure, the inlet part and the outlet part are inserted and connected to fastening parts of the filter heads. The housing and the fastening part are respectively provided with a projection part and a depression part, so that the projection part and the depression part may match. The connection part includes a connection body, a third cap and a fourth cap are coupled to both sides of the connection body, and the third cap and the fourth cap are inserted into the fastening parts. A mark may be provided on an outer surface of the filter accommodation part so as to indicate a direction in which the filter head is connected. Gaskets are positioned at the filter head and the inlet part, the filter head and the connection part, and the filter head and the outlet part, and the gaskets may be in the form of a tube.

### Advantageous Effect

According to the present disclosure, a filter head module for a water purifier improves connection structure of filter heads, thereby enabling the filter heads to be easily assembled and/or disassembled, blocking water leakage due to combination of a plurality of the filter heads, preventing separation of parts, and sufficiently satisfying physical properties such as prevention of eccentricity.

### BRIEF DESCRIPTION OF THE DRAWINGS

FIG. 1 is a perspective view to explain a filter head module according to the present disclosure.

FIG. 2 is a cross-sectional view taken along line II-II in FIG. 1.

FIG. 3 is an exploded view showing a filter head module according to the present disclosure.

FIG. 4 is a cross-sectional view taken along line IV-IV in FIG. 3.

FIG. 5 is a perspective view showing a gasket according to the present disclosure, and

FIG. 6 is a view showing a filter head module according to a modified example of the present disclosure.

Explanation of Reference Characters

| | |
|---|---|
| 100, 100a: Filter head module | |
| 200: Filter part | 201: Filter |
| 10: Inlet part | 11: Inlet stem |
| 12: Inlet tube | |
| 13, 22, 43, 44, 53: First to fifth cap | |
| 20: Filter head | 21: Housing |
| 23: Gasket | 24: Collet |
| 25: O-ring | 26: Fastening part |
| 27: Projection part | 28: Depression part |
| 29: Joining part | 30: Grip |
| 31: Filter accommodation part | 32: Mark |
| 40: Connection part | 41: Connection body |
| 42: Connection tube | 45: Fixing part |
| 50: Outlet part | 51: Outlet stem |
| 52: Outlet tube | |

### DESCRIPTION OF THE DISCLOSURE

Hereinafter, preferred embodiments of the present disclosure will be described in detail with reference to the accompanying drawings. The embodiments described hereinafter may be modified into various other forms, and the scope of the present disclosure is not limited to the embodiments described hereinafter. The embodiments of the present disclosure are provided to more fully explain the present disclosure to those skilled in the art. Meanwhile, terms indicating location, such as top, bottom, front, etc., are only related to what is shown in the drawings. In practice, a filter head can be used in any optional orientation, and in actual use, the spatial orientation changes depending on the orientation and rotation of the filter head.

According to embodiments of the present disclosure, there is provided a filter head module for a water purifier, which improves connection structure of filter heads, thereby enabling filters to be easily assembled and/or disassembled, blocking water leakage due to combination of a plurality of filter heads, preventing separation of parts, and sufficiently satisfying physical properties such as prevention of eccentricity. To this end, a filter head module for a water purifier to which a combination structure of filter heads is applied will be examined in detail, and process of producing a module by assembling filter heads with the combination structure will be explained in detail. A filter head module according to an embodiment of the present disclosure is applied to a water purification device that converts raw water such as tap water or groundwater into safe and hygienic drinking water by filtering various harmful components, which are contained in the raw water and harmful to the human body.

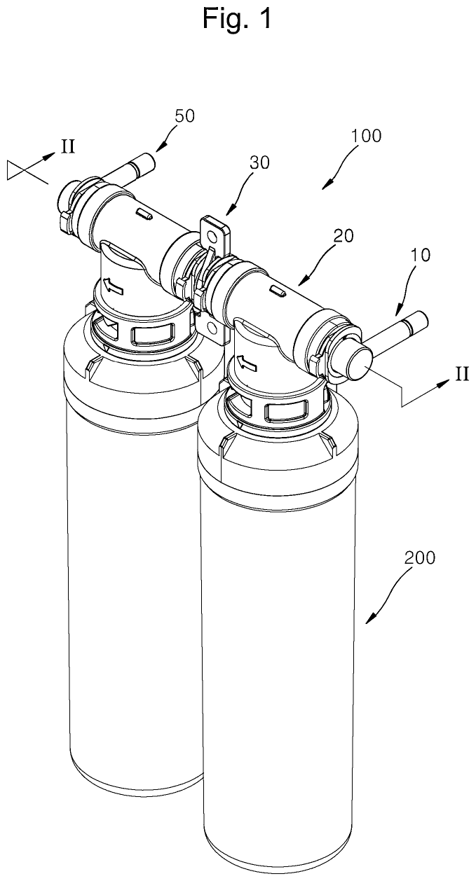

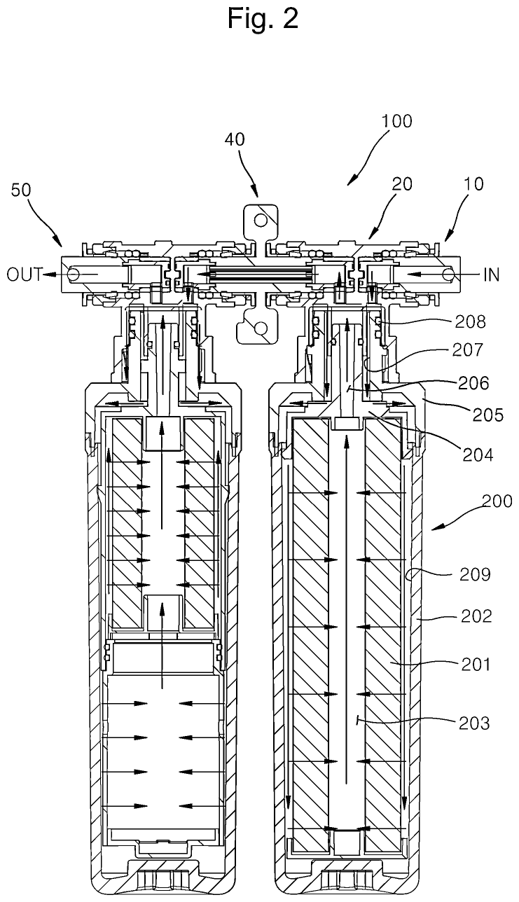

FIG. 1 is a perspective view to explain a filter head module 100 according to an embodiment of the present disclosure, and FIG. 2 is a cross-sectional view taken along line II-II in FIG. 1. However, FIG. 1 and FIG. 2 do not represent drawings in the strict sense, and there may be components not shown for convenience of explanation.

Referring to FIG. 1 and FIG. 2, a filter head module 100 includes an inlet part 10, a filter head 20, a connection part 40 and an outlet part 50, which will be explained in detail later. A filter part 200 is separated from the filter head 20 for replacement and inspection. To this end, the filter head 20 has function of preventing raw water from leaking to the outside and preventing the raw water from flowing into a purification line while blocking a flow path of the purification line. By the function, raw water and purified water are blocked from mixing with each other. The filter head 20 requires many functions such as backflow prevention, water supply blocking, and easy replacement. The filter part 200 may include a filter 201, such as a sediment filter, a pre-carbon filter, a membrane filter or a reverse osmosis filter R/O, a post-carbon filter, etc.

The filter 201 is built into a filter case 202, and has a filter hollow portion 203 inside. The filter 201 is covered by a filter cap 204, and the filter case 202 is covered by a cover 205. The filter cap 204 includes an outlet flow path 206 communicating with the filter hollow portion 203, and an inlet flow path 207 is provided between the filter cap 204 and the cover 205. The cover 205 and the filter head 20 are sealed by an O-ring 208. Raw water IN introduced through an inlet stem 11 flows from the inlet flow path 207 through a filter flow path 209 between the filter case 202 and the filter 201.

The raw water IN in the filter flow path 209 is converted into intermediate purified water through the filter 201 and stored in the filter hollow portion 203. The intermediate purified water stored in the filter hollow portion 203 is discharged through the outlet flow path 206 and the filter head 20. The intermediate purified water passes through the connection part 40 and is discharged as drinking water OUT through a filter part 200 placed next. In the drawings, two filter parts 200 positioned between the inlet part 10 and the outlet part 50 are used as an example, and the intermediate purified water and the drinking water OUT are purified water processed by each filter part 200. Herein, the drinking water OUT is safe and hygienic as various harmful components harmful to the human body are filtered out. In some cases, more than two filter parts 200 may be provided, wherein even if more than two filter parts 200 are installed, drinking water OUT is discharged from a filter part 200 connected to the outlet part 50.

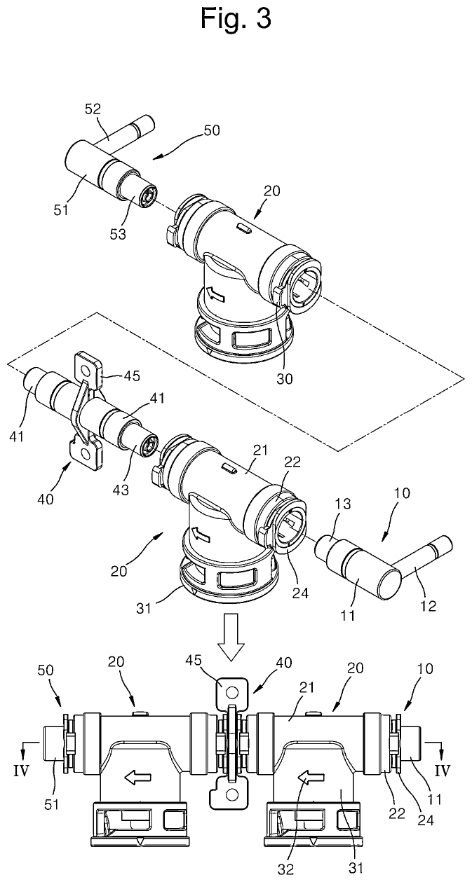

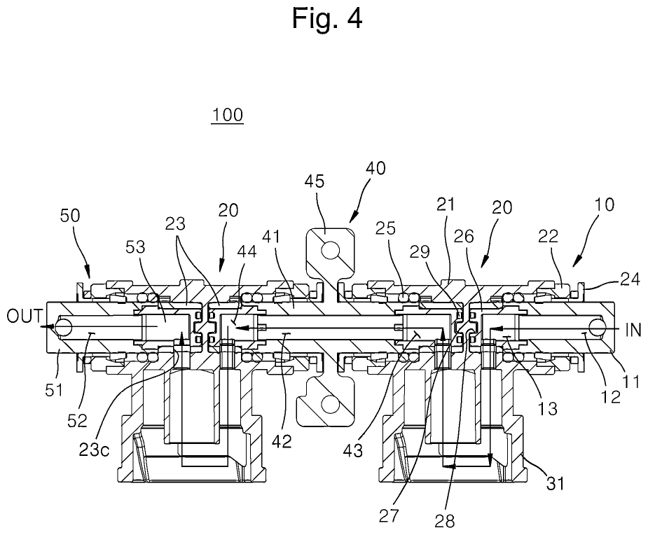

FIG. 3 is an exploded view showing a filter head module 100 according to an embodiment of the present disclosure, and FIG. 4 is a cross-sectional view taken along line IV-IV in FIG. 3. Herein, filter parts 200 mounted on the filter head module 100 are the same as those described above.

Referring to FIG. 3 and FIG. 4, the filter head module 100 may include an inlet part 10, a filter head 20, a connection part 40 and an outlet part 50. Two or more filter heads 20 are positioned between the inlet part 10 and the outlet part 50, and the connection part 40 is positioned between the filter heads 20 so as to connect the filter heads 20. The inlet part 10 provides a flow path through which raw water IN flows and includes an inlet stem 11. The outlet part 50 provides a flow path through which drinking water flows and includes an outlet stem 51. An inlet tube 12 is connected to the inlet stem 11, and a first cap 13 is provided at an end of the inlet tube 12. An outlet tube 52 is connected to the outlet stem 51, and a fifth cap 53 is provided at an end of the outlet tube 52.

Herein, parts of the first cap 13 and the fifth cap 53 are exposed to the outside of the inlet stem 11 and the outlet stem 51, respectively. The inlet tube 12 and the first cap 13 are fixed to the inlet stem 11, and the outlet tube 52 and the fifth cap 53 are fixed to the outlet stem 51. At this time, the first cap 13 and the fifth cap 53 close the ends of the inlet stem 11 and the outlet stem 53, respectively, and facilitate connection with the filter heads 20. For this purpose, the first cap 13 and the fifth cap 53 can be made of flexible materials such as silicone and Teflon.

In order to prevent water leakage, the inlet stem 11 and the inlet tube 12 are molded into a single body, and the outlet stem 51 and the outlet tube 52 are also molded into a single body. When the inlet stem 11 and the inlet tube 12 are molded into a single body and the outlet stem 51 and the outlet tube 52 are also molded into a single body, no gap occurs between the inlet stem 11 and the inlet tube 12 and no gap occurs between the outlet stem 51 and the outlet tube 52. In addition, the inlet stem 11 and the first cap 13 are firmly joined by, for example, fusion using ultrasonic waves, and the outlet stem 51 and the fifth cap 53 are also firmly joined by, for example, fusion using ultrasonic waves. If the inlet stem 11 and the first cap 13 are joined by fusion using ultrasonic waves and the outlet stem 51 and the fifth cap 53 are also joined by fusion using ultrasonic waves, even when high water pressure is applied, no gap is created between the inlet stem 11 and the first cap 13 and between the outlet stem 51 and the fifth cap 53, thereby preventing water leakage.

Each filter head 20 accommodates each filter part 200 and blocks water leakage, and includes a housing 21 and a filter accommodation part 31. A second cap 22, gaskets 23, collets 24 and O-rings 25 are coupled to the inside of the housing 21. At this time, the second cap 22 closes an end of the housing 21 and facilitates coupling to a collet 24. For this purpose, the second cap 22 may be made of flexible materials such as silicone and Teflon. The collet 24 is inserted into the second cap 22, and the second cap 22 is firmly joined to the housing 21 by, for example, fusion using ultrasonic waves. If the second cap 22 is firmly joined to the housing 21 by ultrasonic waves, no gap is created between the second cap 22 and the housing 21 even when high water pressure is applied thereto, thereby preventing water leakage.

In some cases, a grip 30 is additionally provided between the second cap 22 and the collet 24 so as to ensure a stable connection between the second cap 22 and the collet 24. For convenience of explanation, the grip 30 is shown only in the exploded view and omitted in the other drawing. Gaskets 23 and O-rings 25 carry out sealing so as to block water leakage when the inlet part 10 and the connection part 40 are inserted into the housing 21. Likewise, gaskets 23 and O-rings 25 carry out sealing so as to block water leakage when the outlet part 50 and the connection part 40 are inserted into the housing 21. All known methods can be applied to the O-rings 25, and various modifications can be made within the scope of the present disclosure. The gaskets 23 will be explained in detail later.

The inlet part 10 and the outlet part 50 are connected to fastening parts 26 provided on the filter heads 20. Specifically, the first cap 13 and the fifth cap 53 are respectively inserted into the inside of the fastening parts 26, and the ends of the inlet stem 11 and the outlet stem 51 are coupled to the outside of the fastening parts 26. The housings 21 are provided with projection parts 27 and the fastening parts 26 are provided with depression parts 28, so that the projection parts 27 and the depression parts 28 can match each other. If the projection parts 27 and the depression parts 28 match each other, the filter accommodation parts 31, where the filter parts 200 are inserted, are prevented from being distorted. In some cases, the purpose of preventing distortion can be achieved by providing the depression parts 28 to the housings 21 and the projection parts 27 to the fastening parts 26. The fastening parts 26 can be made integrally with the housings 21, but can be joined by joining parts 29 as shown.

Meanwhile, on outer surfaces of the filter accommodation parts 31, there may be marks 32 like an arrow to indicate a direction in which the filter heads 20 are connected by the connection part 40. The marks 32 specify the direction in which raw water IN is converted into drinking water OUT, that is, the positions of the inlet part 10 and the outlet part 50. In the process of assembling filter heads 20, the filter heads 20 are combined in the same direction as the marks 32 indicate.

The connection part 40 includes a connection body 41, a connection tube 42 and fixing parts 45. The fixing parts 45 fix the filter head module 100 to a water purification device. Specifically, the fixing parts 45 can fix the filter head module 100 to a water purification device with fastening screws by using holes in the fixing parts 45, as an example herein, and can be modified and used in various ways within the scope of the present invention. The connection body 41 are provided with a third cap 43 and a fourth cap 44, which are firmly joined on both sides of the connection body 41 by fusion, for example, by ultrasonic waves. Herein, the third and fourth caps 43, 44 close one side and the other side of the connection body 41, respectively, and facilitate combination to the filter heads 20. To this end, the third and fourth caps 43, 44 may be made of flexible materials such as silicone and Teflon. If ultrasonic fusion is performed, even when high water pressure is applied, no gap is created between the connection body 41 and the third cap 43 and between the connection body 41 and the fourth cap 44, thereby preventing water leakage.

The collets 24 are cylindrical and have a strip shape, and the strip-shaped collets 24 are assembled in close contact with the fixing parts 45. The collets 24 limit the connection part 40 to be inserted into the filter heads 20 to a certain degree. The fixing parts 35 serve as stoppers to limit the movement of the collets 24. If the collets 24 do not exist, the degree to which the connection part 40 is inserted into the filter heads 20 may not be constant. In other words, one side of the connection part 40 may be thinly inserted into a filter head 20 and assembly may not be performed properly. In this case, assembly is not easily completed, and disassembly is also difficult due to an imbalance in power. Using the collets 24, the connection part 40 and the filter heads 20 can be easily assembled and disassembled.

The third cap 43 and the fourth cap 44 are coupled to the fastening parts 26 provided on the filter heads 20. Specifically, the third cap 43 and the fourth cap 44 are respectively inserted into the inside of the fastening parts 26, and ends of the connection body 41 are coupled to the outside of the fastening parts 26. To this end, the projection parts 27 are provided on the housings 21 and the depression parts 28 are provided on the fastening parts 26 so as to be aligned with each other. If the projection parts 27 and the depression parts 28 match each other, the filter accommodation parts 31, where the filter parts 200 are inserted, are prevented from being distorted. In some cases, the purpose of preventing distortion can be achieved by providing the depression parts 28 to the housings 21 and the projection parts 27 to the fastening parts 26.

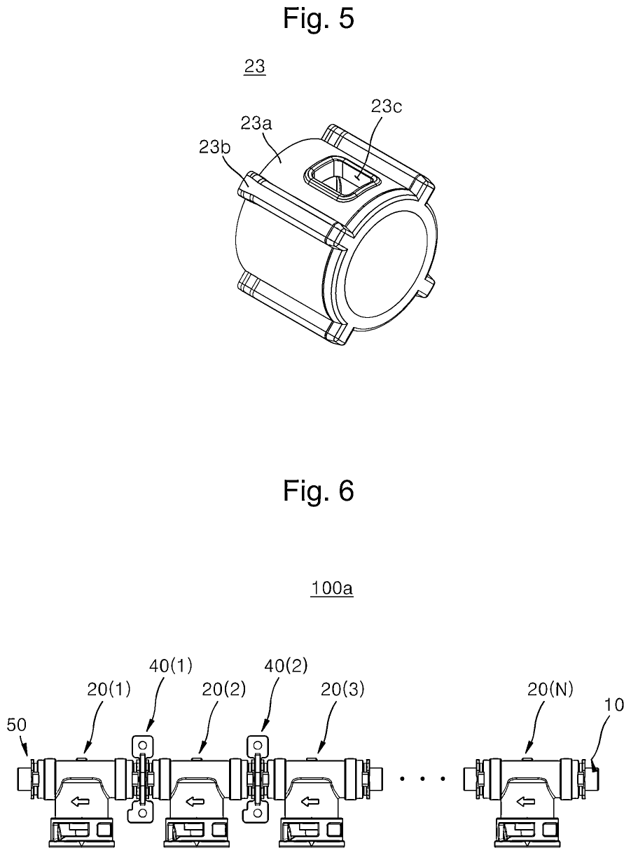

FIG. 5 is a perspective view showing a gasket 23 according to an embodiment of the present disclosure. Herein, a filter head module 100 is the same as that described above.

Each gasket 23 as shown in FIG. 5 are positioned between the inlet part 10 and the filter head 20, between the filter heads 20 and the connection part 40, and between the filter head 20 and the outlet part 50, respectively. The gasket 23 includes a gasket body 23a, gasket pins 23b and a flow hole 23c. The gasket 23 is in the form of a tube so as to surround the inlet stem 11, the connection body 41 and the outlet stem 51. If such gaskets 23 respectively surround the inlet stem 11, the connection body 41 and the outlet stem 51 in a tube shape, the gaskets 23 prevent eccentricity from occurring when the inlet part 10, the connection part 40 and the outlet part 50 are assembled to the filter heads 20. If the gaskets 23 surround the inlet stem 11, the connection body 41 and the outlet stem 51 in a ring shape as in the prior art, eccentricity occurs when the inlet part 10, the connection part 40 and the outlet part 50 are assembled to the filter heads 20.

FIG. 6 is a view showing a filter head module 100a according to a modified example of the present disclosure. Herein, description of a filter head module 100 will be omitted with reference to FIG. 3 and FIG. 4.

Referring to FIG. 6, in a filter head module 100a according to a modified example of the present disclosure, more than two filter heads, that is, N filter heads 20(1), 20(2), 20(3), . . . , 20(N) (N is a natural number greater than 2) are combined by N−1 connection parts 40(1), 40(2), . . . , 40(N−1). Specifically, the filter head module 100a according to a modified example of the present disclosure is completed by assembling collets 24 of the filter heads 20(1), 20(2), 20(3), . . . , 20(N) to fixing parts 45 of the connection parts 40(1), 40(2), 40(N−1) in close contact. In this way, the filter head module 100a according to the modified example that includes the N filter heads 20(1), 20(2), 20(3), . . . , 20(N) (N is a natural number greater than 2) may be easily completed by bringing the collets 24 in close contact with the fixing parts 45. In the process of assembling the N filter heads, the N filter heads are combined in a same direction as marks 32 indicate.

Hereinabove, the present disclosure has been described in detail with preferred embodiments, but the present disclosure is not limited to the embodiments and various modifications may be made by those skilled in the art within the scope of the technical idea of the present disclosure.

What is claimed is:

1. A filter head module for a water purifier, comprising:
a plurality of filter heads including each filter accommodation part in which a filter part is accommodated; and
a connection part for connecting the filter heads,
wherein each of the filter heads includes a housing, a second cap and a collet, the second cap is coupled to the housing, and the collet is in close contact with a fixing part of the connection part.

2. The filter head module for a water purifier according to claim 1, wherein the housing and the second cap are fused by ultrasonic waves.

3. The filter head module for a water purifier according to claim 1, wherein the filter head is positioned between an inlet part and an outlet part, the inlet part includes an inlet stem and a first cap, and the outlet part includes an outlet stem and a fifth cap.

4. The filter head module for a water purifier according to claim 3, wherein the inlet stem and the first cap are fused by ultrasonic waves, and the outlet stem and the fifth cap are fused by ultrasonic waves.

5. The filter head module for a water purifier according to claim 1, wherein the inlet part and the outlet part are inserted and connected to fastening parts of the filter heads.

6. The filter head module for a water purifier according to claim 5, wherein the housing and the fastening part are respectively provided with a projection part and a depression part, so that the projection part and the depression part match.

7. The filter head module for a water purifier according to claim 5, wherein the connection part includes a connection body, a third cap and a fourth cap are coupled to both sides of the connection body, and the third cap and the fourth cap are inserted into the fastening parts.

8. The filter head module for a water purifier according to claim 1, wherein a mark is provided on an outer surface of the filter accommodation part and indicates a direction in which the filter head is connected.

9. The filter head module for a water purifier according to claim 3, wherein gaskets are positioned at the filter head and the inlet part, the filter head and the connection part, and the filter head and the outlet part, and the gaskets are in the form of a tube.
